(19) United States
(12) Patent Application Publication
(10) Pub. No.: US 2012/0176636 A1
(43) Pub. Date: Jul. 12, 2012

(54) REAL-TIME CONSUMABLES MANAGEMENT

(75) Inventor: Louis Ormond, Irvine, CA (US)

(73) Assignees: Toshiba Tec Kabushiki Kaisha, Shinagawa-ku (JP); Kabushiki Kaisha Toshiba, Minato-ku (JP)

(21) Appl. No.: 13/308,280

(22) Filed: Nov. 30, 2011

Related U.S. Application Data
(60) Provisional application No. 61/431,792, filed on Jan. 11, 2011.

(51) Int. Cl. G06K 15/02

(52) U.S. Cl. 358/1.13

(57) ABSTRACT

There is disclosed a method and system for real time consumables management for multifunction peripheral devices. The method includes receiving a consumable insertion notification in response to the insertion of the consumable into a multifunction peripheral device, the insertion notification including a unique identifier for the multifunction peripheral device. The method also includes receiving an update regarding a status of the consumable from the multifunction peripheral device and generating a depletion notification when the update indicates that the consumable has reached a predetermined threshold of depletion. The method also includes processing an order for the consumable in response to the depletion notification, the order using the unique identifier to obtain billing preference data and shipping preference data for the multifunction peripheral device obtained from a database.

### RELATED APPLICATION INFORMATION

This patent claims priority from U.S. Provisional Patent Application No. 61/431,792 entitled “Hosted Intelligence Device Management” filed Jan. 11, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to real-time consumables management.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical). A document processing request is a request to an MFP to perform at least one document processing function.

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

MFPs rely upon a number of consumables in order to operate. Management of these consumables is a time-consuming and mundane task for system administrators of these devices. System administrators are required to manually maintain an inventory of the appropriate types of toners, staples, paper and other consumables for each type of MFP.

Maintaining an appropriate inventory of consumables requires the system administrator to ascertain and maintain a record of the number and types of MFPs on site at a particular location. In addition, the system administrator must continually maintain and update an inventory of the consumables both currently being used by the MFPs and available for use as replacements for those currently being used.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is an example of a web interface for use in real-time consumables management.

FIG. 6 is an example of an MFP interface for use in real-time consumables management.

FIG. 7 is a flowchart for a server including access to a web interface for use in real-time consumables management.

FIG. 8 is a flowchart for a server using automatic monitoring in real-time consumables management.

FIG. 9 is a flowchart for the MFP for use in real-time consumables management.

Throughout this description, elements appearing in figures are assigned three-digit reference designators, where the most significant digit is the figure number and the two least significant digits are specific to the element.

### DETAILED DESCRIPTION

The present application is directed to a system, method and apparatus whereby a remote server may maintain a database of each, specific consumable shipped to one or more customers in addition to the specific consumable inserted into a group of MFPs associated with one or more customers. The status of depletion of those consumables may be reported back, by the MFPs, to the server so that when a specific depletion status is received for an MFP, various options may be presented to an administrator.

The administrator may set an automatic order for consumables upon a predetermined depletion status. The administrator may provide billing and shipping preference data such that the order will automatically be filled and shipped without intervention. The administrator may set a prompt to ask the administrator to place an order in response to a predetermined depletion status. The order for consumables may be placed automatically or in response to a prompt via a web interface, stand alone application, mobile application, mobile device, text message, email or other method. The predetermined depletion status may be stored on the server or on the MFP.

Description of Apparatus

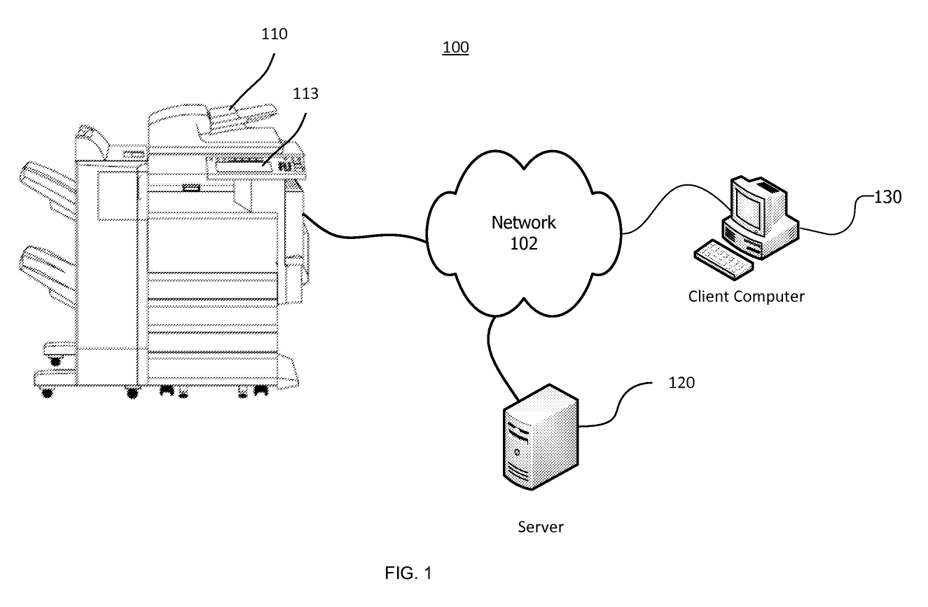

FIG. 1 shows a block diagram of a system 100. The system 100 includes an MFP 110, a server 120, and a client computer 130, all interconnected by a network 102. The system 100 may be, for example, implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WIMAX®, BLUETOOTH®, the public switched telephone network, a proprietary communications network, infrared, and optical.

The MFP 110 may be equipped to receive portable storage media such as a USB drive. The MFP 110 may include a user interface subsystem 113 which communicates information to and receives selections from users. The user interface subsystem 113 may have a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The server 120 may include software operating on a server computer connected to the network. The client computer 130 may be a PC, thin client or other device. The client computer 130 is representative of one or more end-user devices and may be considered separate from the system 100.

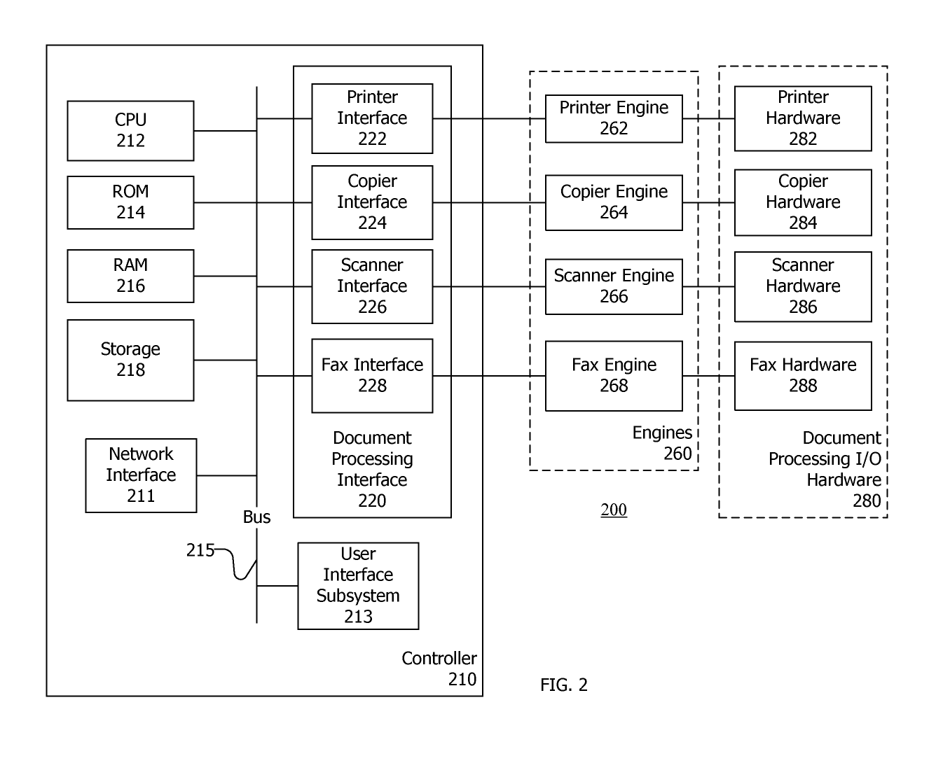

Turning now to FIG. 2, there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state storage. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions. These engines may be software, firmware or a combination of both that enables the document processing interface 220 to communicate with the document processing I/O hardware 280.

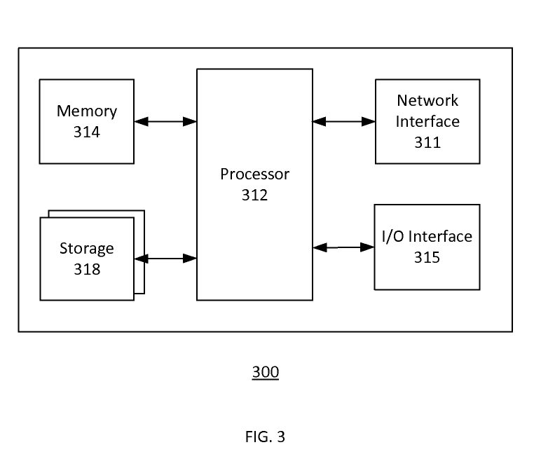

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

As used herein, the term storage medium corresponds to the storage 318 (or 218 in FIG. 2) and does not include transitory media such as signals or waveforms.

The network interface 311 includes an interface to a network such as network 102 (FIG. 1).

The I/O interface 315 interfaces the processor 312 to peripherals (not shown) such as displays, keyboards and USB devices.

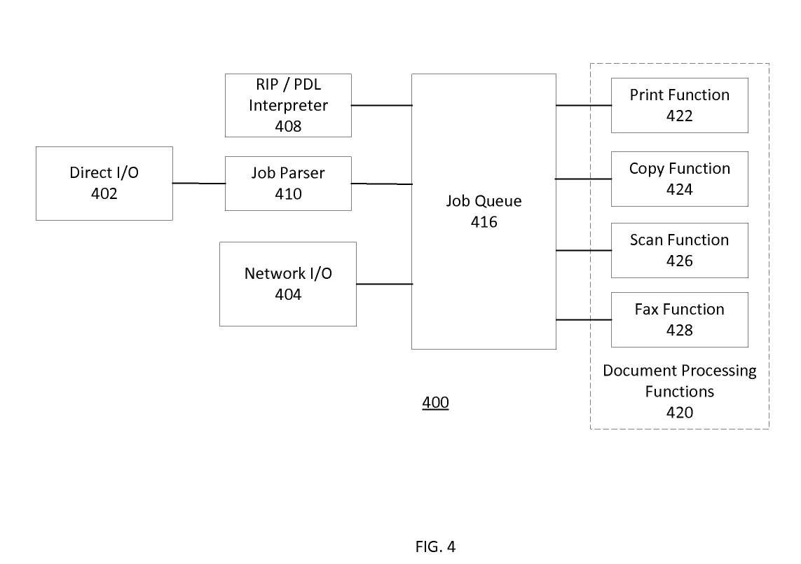

Turning now to FIG. 4 there is shown a block diagram of a software system 400 of an MFP which may operate on the controller 210 (FIG. 2). The system 400 includes direct I/O 402, network I/O 404, a RIP/PDL interpreter 408, a job parser 410, a job queue 416, a series of document processing functions 420 including a print function 422, a copy function 424, a scan function 426 and a fax function 428.

The direct I/O 402 and the network I/O 404 provide input and output to the MFP controller. The direct I/O 402 is for the user interface on the MFP (e.g., user interface subsystem 113), and the network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail, TELNET, or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the direct I/O 402. The direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

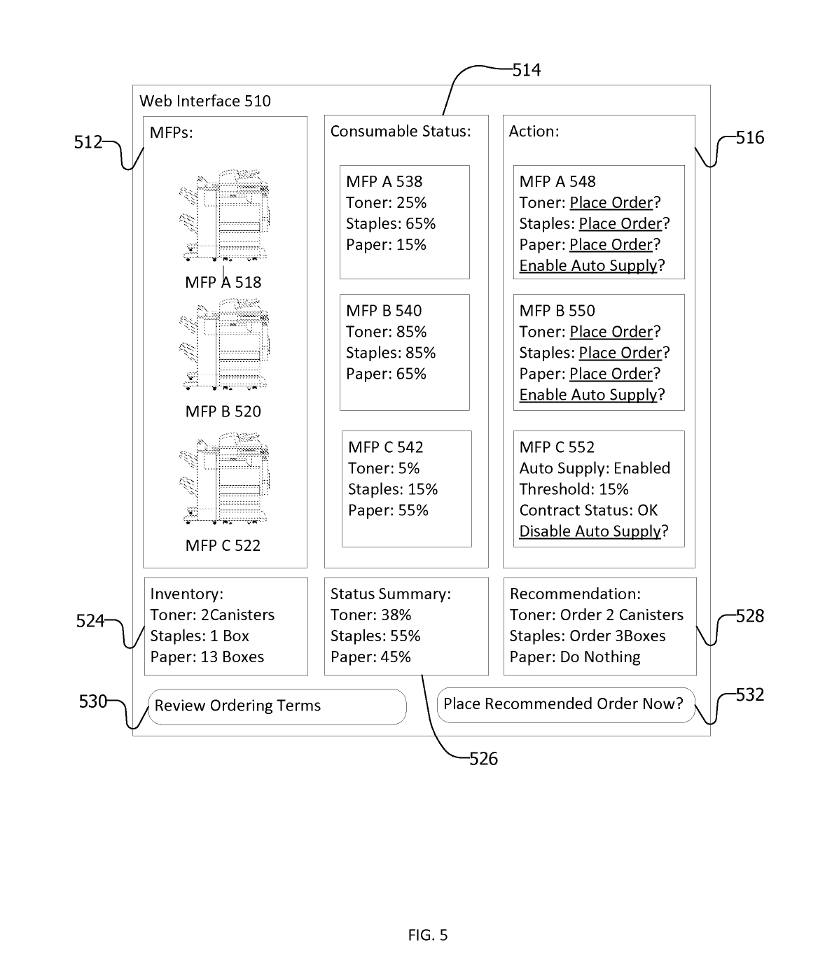

FIG. 5 is an example of a web interface for use in real-time consumables management. The web interface 510 may be a part of a single web page or made up of a series of web pages. The web interface 510 is only shown as an example of one way to present the information described. Different web pages, stand-alone applications or mobile applications may be used to present the information shown in the web interface 510. Additional or fewer categories of information may be included and the way in which they are presented may be different from that shown in FIG. 5.

The web interface 510 includes an MFP listing 512, a consumable status 514 for each of the MFPs appearing in the MFP listing 512, an action bar 516, an inventory 524, a status summary 526, a recommendation box 528. Also included are two buttons, the first an order terms button 530 and the second a recommended order button 532.

The MFP listing 512 is compiled by a server, such as server 120 (FIG. 1) based upon the MFPs reporting back to the server. Each MFP may incorporate unique indicia in memory, such as a serial number and/or model number. This unique indicia may be transmitted by the MFP to the server for reporting. In this way, the server may maintain a database of the current status of each MFP associated, for example, with a particular customer. Alternatively, the MFP listing 512 may be created based upon the serial numbers of the MFPs known to have been provided to a particular customer.

The MFP listing 512 includes MFP A 518, MFP B 520 and MFP C 522. Additional or fewer MFPs may be shown in this listing. These three are only shown as an example. The MFP listing 512 may include all MFPs associated with a particular customer. These MFPS may be visible in an MFP listing 512 provided to an administrator associated with that customer. Alternatively, the MFP listing 512 may be available to a customer service representative who is responsible for servicing the MFPs and may be operated by a plurality of different customers. Such a customer service representative may have access to all of its customer's MFPs.

Each MFP in the MFP listing 512 includes a consumable status 514. For example, MFP A 518 has a corresponding MFP A status 538, MFP B has a corresponding MFP B status 540 and MFP C has a corresponding MFP C status 542. The status 538, 540 and 542 provide information regarding the current status of consumables in each corresponding MFP, 518, 520, 522.

MFP A status 538, for example, shows that toner is at 25%, staples are at 65% and paper is at 15%. These numbers indicate the current remaining capacity of each of these consumables in MFP A 518. Additional or fewer consumables may be monitored, these are only presented as an example. MFP B status 540 shows that toner is at 85%, staples are at 85% and paper is at 65%. MFP C status 542 shows that toner is at 5%, staples are at 15% and paper is at 55%.

Each of the MFP status, 538, 540 and 542 are generated based upon updates provided, automatically, by each MFP to a central server as to the current state of their consumables use. Alternatively, a date upon which the consumable was inserted and historical data may be used to derive an average usage lifespan for each consumable and to, thereby, estimate the current consumable status for a particular MFP.

Each MFP 518, 520 and 522 in the MFP listing 512 also has a corresponding MFP A actions 548, MFP B actions 550 and MFP C actions 552, respectively, in the action bar 516. MFP A actions 548 include the opportunity to place orders for toner, staples, paper or to enable auto supply functionality.

An administrator's request to place an order for, for example, toner for MFP A 518 using the MFP A actions 548 begins the process of placing an order for MFP A 518. That process may be simplified based upon the system's knowledge regarding the model number, location, billing terms, shipping terms and other information related to MFP A 518.

An administrator's request to enable auto supply will indicate to the server that for MFP A 518, the administrator wishes to enable the server to actively monitor MFP A status 538 and, in response to certain thresholds, automatically order replacement consumables using the model number, location, billing terms, shipping terms and other information related to MFP A 518 when the consumable status has reached a predetermined threshold of depletion.

As can be seen, MFP C actions 552 indicates that auto supply has been enabled and provides a prompt to disable auto supply and further indicates that the contract status is “OK.” This information pertains to the current service contract for MFP C 522. If there is any issue with the location, billing terms, shipping terms or other information related to MFP C 522, then the MCP C action 552 may enable a user to update that information via a link in MFP C action 552. MFP C action 552 also shows the threshold set by an administrator for automatically reordering consumables. These thresholds may be set for all consumables or for each consumable individually.

The inventory 524 is an overall inventory of available consumables for use in MFPs A 518, B 520 and C 522. The system can associate consumables already shipped to a particular customer, but not yet used by that customer, with the customer. In addition, a canister of toner, for example, may incorporate a microchip that, upon insertion into an MFP, may prompt an update to a database associated with the web interface 510 such that the insertion of that toner is noted. The inventory 524 should present an accurate count of available replacement consumables. If multiple types of multifunction peripherals are used, then the inventory 524 may be itemized according to the MFP models.

The status summary 526 provides a current overall picture of the consumable status 514. The recommendation box 528 provides a recommendation for the administrator as to how best to maintain adequate inventory of consumables. The recommendation may be based upon historical usage of the various consumables in addition to average life spans of consumable types across all MFPs of a particular customer or of all MFPs of a particular type sold by a manufacturer. It may also be based upon the total number of each model of MFP that a particular customer has on their premises.

The ordering terms button 530 provides an opportunity for the administrator to review the service contract governing the MFPs listed in MFP listing 512, prices associated with the purchase of consumables and the current state of the relationship between the parties.

The recommended order button 532 enables the administrator to place the order appearing in the recommendation box 528 with limited additional input necessary. Selecting the recommended order button 532 causes the server to obtain billing and shipping information for all recommended orders and to automatically process the recommended order for shipment. Only a confirmation is necessary for the order to ship, if all contract terms are in order and available in the associated database.

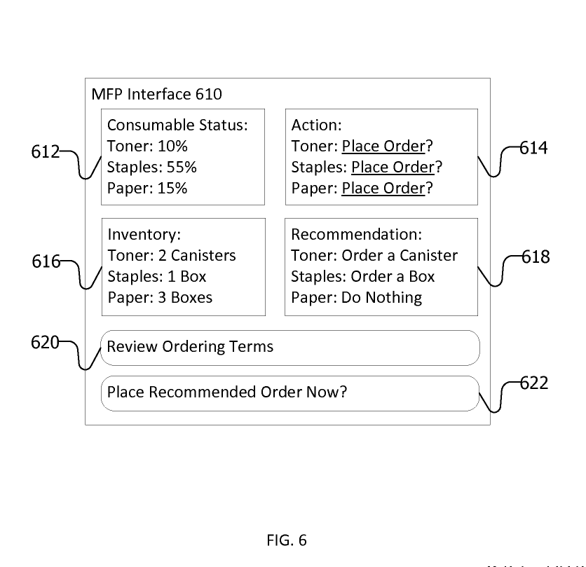

FIG. 6 is an example of an MFP interface for use in real-time consumables management. The MFP interface 610 includes a consumable status 612, an action box 614, an inventory 616, a recommendation 618, an order terms button 620 and a recommended order button 622.

The MFP interface may be shown, for example, on the user interface subsystem 113 (FIG. 1) using the user interface subsystem 213 (FIG. 2). The MFP interface 610 may be presented to an administrator or user of an MFP upon a determination that the MFP is running low on one or more consumables. The MFP interface 610 displays less information than the web interface 510 because the MFP interface 610 shows information pertaining to only the MFP on which it is displayed.

The consumables status 612 shows that toner is at 15% capacity, staples are at 55% and paper is at 15%. The action box 614 provides the user with the opportunity, directly from the MFP user interface, to place an order for any of the consumables. The “place order” links direct a user or administrator to an order form where an order can be placed with minimal additional user input. The inventory 616, like inventory 524 (FIG. 5) shows the currently-available inventory of consumables not currently in use in any MFP.

The recommendation 618 provides the user or administrator with a recommendation of what consumables to purchase and in what amounts. The recommendation at this MFP is to order one canister of toner and one box of staples. Before requesting such an order, the order terms button 620 may be selected whereby a user can review the prices, service contract status and other information pertaining to an order placed via the action box 614 or as suggested by the recommendation 618. The user may place the recommended order by selecting the recommended order button 622.

When an order is placed using the action box 614, the user need only provide the desired quantities of each consumable. In the case of the recommended order button 622, nothing need be provided by a user but the user's confirmation of the recommended order 618. In either case, the order is placed using the model and serial number of the MFP along with information available to a remote database including the billing preferences and shipping preferences for the consumables ordered.

Description of Process

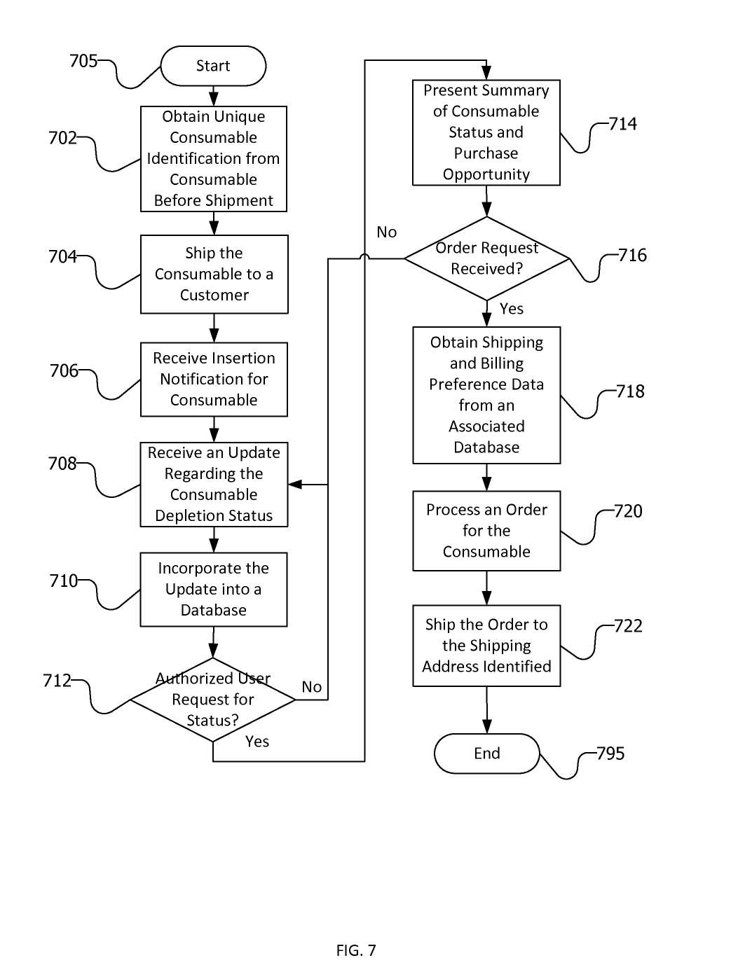

FIG. 7 is a flowchart for a server including access to a web interface for use in real-time consumables management. The server, such as server 120 (FIG. 1), may first obtain a unique consumable identification from the consumable at 702. The unique consumable identification may be entered manually, be scanned via RFID, barcode, QR code or other method using a scanner. This unique consumable identification may be used to uniquely identify an individual, for example, toner cartridge before it is shipped to a particular customer.

By identifying each consumable uniquely before shipment, the server may maintain a database of used (and returned), in-use and as of yet unused consumables at a particular customer or customer location. Specifically, the data regarding the consumables sent to a particular customer or customer location when coupled with data provided by each MFP as to the consumables currently in use and data regarding the consumables returned will result in a complete picture of all consumables currently at a particular customer or customer location.

After the consumable is uniquely identified before shipment, it may be shipped to a customer at 704. Once shipped, the database is updated to indicate the customer or customer location to which the consumable was shipped. This information is used to update an inventory of consumables currently at the customer or customer's location in the database.

Next, the system may receive an insertion notification for the consumable at 706. As the consumable is inserted into an MFP for the first time, the MFP may activate a microchip on the consumable or may scan a barcode, QR code RFID chip or other identification technology. Alternatively, an individual may manually scan the consumable using the MFP's scanning equipment prior to installation of the consumable or be required to input a unique code on the exterior of the consumable via the MFP's user interface subsystem 113 (FIG. 1).

Once received, the MFP will transmit an insertion notification including the unique consumable identification, via a network, such as network 102 (FIG. 1) to the server. This insertion notification update indicates that the particular consumable has been inserted into a particular MFP. The MFP is also uniquely identified, by serial number and/or model number in the insertion notification. A database on the server is updated to reflect that the consumable has begun being used, the customer's inventory is decremented by one of those consumables and the MFP is identified in the database as utilizing the particular consumable.

Next, the server receives an update regarding the consumable depletion status at 708. The server may receive these updates from a plurality of MFPs, preferably, from every MFP capable of providing such updates and with access to a network connection. In this way, the server may maintain a database of the consumable depletion status for each of the MFPs reporting to the server. The update is incorporated into the database at 710.

The server may continue operating until it receives an authorized user request for status at 712. This request may be a web request, may be the launching of a standalone application or mobile application. This request may require the administrator to input a login and password or other method of authentication in order to authorize the user to receive the status. If the server does not receive valid authorization data from the user, then the system returns to an idle state until it receives the next update regarding the consumable depletion status at 708.

If valid authorization data is received, then the server presents a summary of consumable status and provides an opportunity to purchase consumables at 714. This summary and opportunity may appear in a form similar to that shown in FIG. 5. The authorization data may be associated with an administrator of a set of MFPs. Alternatively, the authorization data may be associated with a customer service representative of the company selling or servicing the MFPs. The administrator will be presented with a summary of all MFPs administered by the administrator. A customer service representative may be presented with a listing of all MFPs, across multiple customers, to which that representative provides service. The listing may be sorted or limited based upon model numbers, consumable status, consumable types, MFP location or various other criteria, including, for the customer service representative, the customer associated with the MFP.

Next, the administrator or customer service representative may place an order that is received at 716. The order may be placed by clicking, for example, the “place order” buttons that appear in the action box 516 (FIG. 5) or a similar user interface element in standalone software or a mobile application. The order may also be placed based upon a recommended order button 532 (FIG. 5) or similar user interface element in standalone software or a mobile application.

If no order request is received, the server awaits a subsequent update regarding the consumable status at 708. If an order is received, via the web interface 510, then the server obtains shipping preference and billing preference data from the database. This shipping and billing data may be defined individually for each customer or for each MFP. For example, one customer may have a single location and account to which all purchases are shipped and billed, respectively. Other customers may have multiple locations and accounts, and an order for one MFP may be billed to one account and shipped to one location while another order for a different MFP may be billed to a different account and shipped to a different location.

Whatever the shipping preference and billing preference data, it is obtained from the database automatically and an order is processed for the consumable ordered at 720. The order may then be shipped to the shipping address identified in the shipping preference data associated with the MFP or MFPs for which the order was placed at 722. In some cases, orders and shipments may be billed to multiple accounts and shipped to multiple locations, but appear to the administrator or customer service representative as a single order. Invoices for all orders are provided according to the contact information associated with each MFP.

The flow chart of FIG. 7 has both a start 705 and an end 795, but the process is cyclical in nature and may include one or more simultaneous instances taking place in parallel or in serial. For example, a large group of MFPs or every MFP capable of reporting back its own consumable depletion status may do so simultaneously.

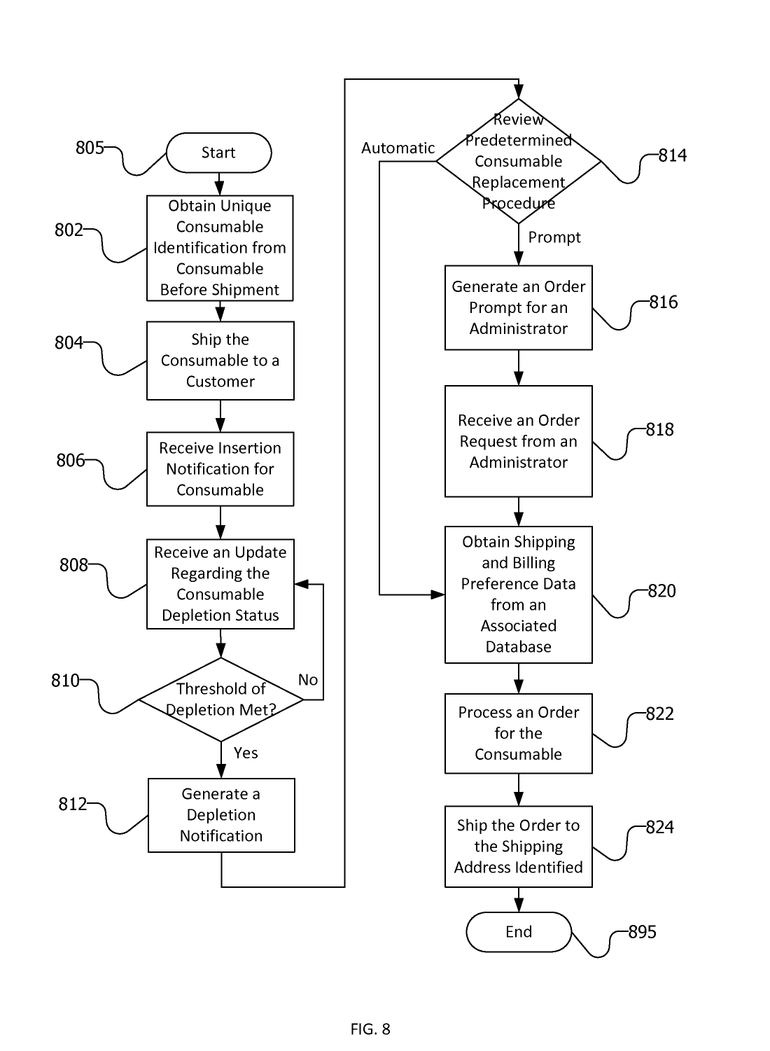

FIG. 8 is a flowchart for a server using automatic monitoring in real-time consumables management. The process starts, as above, by obtaining unique consumable identification for a consumable before it is shipped out to a customer at 802. Next, the consumable is shipped to a consumer at 804 and upon insertion into a MFP, the MFP generates an insertion notification that is received by a server at 806.

Periodically, the MFP will update the status of the depletion of the consumable. These updates are received by the server at 808. This depletion status may be actually monitored by the MFP or may be estimated based upon the total number of pages printed by the MFP since the consumable was inserted. The MFP may itself maintain data pertaining to the current status of the consumable depletion or may report that information in raw form to a server that maintains the data.

The MFP or server, whichever may be responsible for monitoring, may periodically check to determine if a threshold of depletion for that consumable is met at 810. This threshold, like the data, may be maintained by the MFP itself or may be stored on the server. If the threshold is not yet met, the server will await a further update of the consumable depletion status at 808.

If the threshold is met, the server will generate a depletion notification at 812. This notification will indicate to the server the consumable which is almost depleted and the MFP in which that consumable is almost depleted. This identification will uniquely identify the specific consumable canister, for example, for toner that is near depletion. It can be expected that that specific canister will, then, soon be returned to the manufacturer for a replacement toner canister. Similarly, it will indicate the specific MFP which is low on toner, so that a new order may be filled for that MFP and so that it may be billed and shipped to an appropriate address for that MFP.

Next, the server will review the predetermined consumable replacement procedure at 814. This procedure may indicate, for example, that the process of consumable replacement is to take place automatically or that it is to prompt an administrator prior to ordering replacement consumables. The replacement procedure may be set by an administrator of a set of MFPs, via a web interface, stand alone application or mobile application. The replacement procedure may include input of a billing and shipping address for each MFP or for the customer as a whole. If the replacement procedure indicates that it should be automatic, the process proceeds to obtaining shipping and billing information at 820, described below.

If the replacement procedure indicates that it should prompt, then a prompt for an order will be generated for an administrator at 816. The method that this process employs may be set by the administrator of the MFPs or a customer service representative for each MFP or for the customer as a whole. The prompt may be sent via email, via a web interface like web interface 510, via an MFP interface such as MFP interface 610, via text message to a mobile phone, within a mobile application, within a stand alone application, as a screen popup as a part of a monitoring application or through various other methods. The prompt enables an administrator to place an order for the consumable for which the depletion notification was received and to have it delivered to the appropriate location for use with the MFP associated with the depleted consumable.

The administrator or customer service representative can place such an order which is received from the administrator at 818. Once an automatic or administrator-prompted order is received, the server obtains shipping and billing preference data from an associated database at 820. Because each MFP and consumable is uniquely identified in the database, the shipping and billing information specific to that MFP may be obtained and used to process an order for the consumable at 822.

The order will automatically be for the appropriate consumable, because it is based upon a specific consumable that is near depletion and is associated with a particular MFP with a known location, billing preference data, shipping data. The service contract governing the specific MFP may be reviewed in order to obtain pricing information for consumables for that MFP.

Finally, the order is shipped to the address identified at 824 with the MFP from which the depletion notification was received. Because the server acts as a central repository for all information pertaining to the MFP in addition to the current consumable depletion status, the server may most accurately receive, process and fill orders for consumables. These orders may provide just-in-time access to consumables or may provide a customer's MFP administrator the opportunity to maintain a specific inventory of consumables such that when the level of spare consumables drops below a specific point, additional consumables of each of a series of specific types for various MFPs may be ordered by the server.

The flow chart of FIG. 8 has both a start 805 and an end 895, but the process is cyclical in nature and may relate to one or more simultaneous instances taking place in parallel or in serial. For example, a large group of MFPs or every MFP capable of reporting back its own consumable depletion status may do so simultaneously.

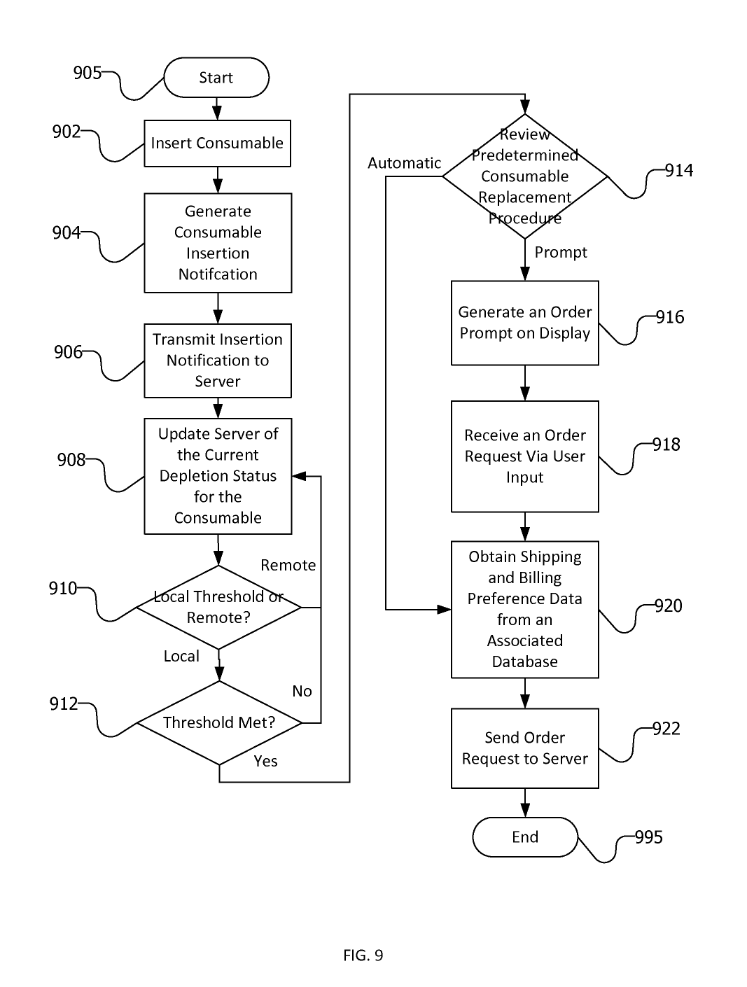

FIG. 9 is a flowchart for the MFP for use in real-time consumables management. This process begins at the MFP, such as MFP 110, upon the insertion of a consumable at 902. This consumable may be, for example, toner, staples, paper or other consumable that is reduced through use.

In response to insertion of the consumable, a consumable insertion notification is generated at 904. This is used to notify a remote server of the insertion of the consumable. In this notification, the specific consumable is identified based upon a microchip no the consumable, a serial number, microchip, RFID tag, barcode, QR code, user scanning a portion of the consumable using the MFP or other uniquely-identifiable tag. The consumable has previously been uniquely identified before it was sent to a customer. In addition, this insertion notification includes a unique identifier associated with the MFP into which the consumable was inserted.

Next, the insertion notification is transmitted to a server at 906. The server is then periodically updated as to the depletion status for the consumable at 908. This may take place periodically, such as once nightly, once weekly or once monthly. Alternatively, this may take place after a predetermined number of print jobs or staple operations.

Next, a determination whether a particular threshold is local or remote is made at 910. If the threshold is remote, meaning that depletion status is monitored remotely, then action returns to the process of updating the server of the current depletion status for the consumable at 908. If the threshold is local, meaning that the MFP maintains its own thresholds (for example, in situations in which a single MFP is the only one used by a customer), then a determination is made by the MFP as to whether a depletion threshold is met at 912.

If the depletion threshold is not met at 912, then the process returns to updating the server of the current depletion status for the consumable at 908. If the depletion threshold is met at 912, then a review of the predetermined consumable replacement procedure is made at 914. This process may be automatic or prompt-based. The determination as to whether this process is automatic or prompt-based may be made by an administrator of the MFP.

If the process is automatic, the process moves to obtaining shipping and billing preference data from an associated database at 920. If the process requires a prompt, the process moves to generate an order prompt on display at 916. This display may be the display of the MFP, a computer monitor, a mobile device display or other suitable means to prompt the administrator. The prompt may take any of the forms described above with respect to FIG. 8.

In response to the prompt, an order may be received from the administrator via user input at 918. The prompt may provide all of the necessary parameters to place an order or may request the input of an order by the administrator. Preferably, the order may be generated by an administrator merely confirming a recommended order.

Once the order has been received, either in response to a prompt or by automation, the MFP obtains shipping and billing preference data from an associated database at 920. This database may be locally maintained or may be maintained on a server remote from the MFP. Preferably, this information is maintained in both locations, but the server to which the order is sent maintains the information used in processing the order.

Finally, an order request is sent to the server at 922. This order request identifies the specific consumable that has been depleted, the specific MFP, the location of that MFP, the shipping and billing preference data and any invoicing preferences. The order will then be processed by the server and the replacement consumable sent to the customer.

The flow chart of FIG. 9 has both a start 905 and an end 995, but the process is cyclical in nature and may relate to one or more simultaneous instances taking place in parallel or in serial. For example, a large group of MFPs or every MFP capable of reporting back its own consumable depletion status may do so simultaneously.

It is claimed:

1. A method for real time consumables management for multifunction peripheral devices comprising:
receiving a consumable insertion notification in response to the insertion of the consumable into a multifunction peripheral device, the insertion notification including a unique identifier for the multifunction peripheral device;
receiving an update regarding a status of the consumable from the multifunction peripheral device;
generating a depletion notification when the update indicates that the consumable has reached a predetermined threshold of depletion; and
processing an order for the consumable in response to the depletion notification, the order using the unique identifier to obtain billing preference data and shipping preference data for the multifunction peripheral device obtained from a database.

2. The method of claim 1 wherein the consumable insertion notification includes a consumable unique identifier.

3. The method of claim 2 further comprising inputting the consumable unique identifier into a consumables database prior to providing the consumable for use in the multifunction peripheral.

4. The method of claim 2 wherein the consumable insertion notification is generated by a microchip integral to the consumable and activated by insertion of the consumable into the multifunction peripheral device.

5. The method of claim 1 wherein the order is generated automatically in response to the depletion notification.

6. The method of claim 1 further comprising:
generating an order prompt to an administrator in response to receipt of the depletion notification; and
receiving an order request from the administrator, the order request including the unique identifier.

7. A system for real time consumables management for multifunction peripheral devices including a server comprising:
a network interface for receiving a consumable insertion notification in response to the insertion of the consumable into a multifunction peripheral device, the insertion notification including a unique identifier for the multifunction peripheral device;
the network interface further for receiving an update regarding a status of the consumable from the multifunction peripheral device;
a database for storing billing preference data and shipping preference data for the multifunction peripheral;
a processor for generating a depletion notification when the update indicates that the consumable has reached a predetermined threshold of depletion; and
the processor further for processing an order for the consumable in response to the depletion notification, the processor using the unique identifier to obtain billing preference data and shipping preference data for the multifunction peripheral device obtained from the database.

8. The system of claim 7 wherein the consumable insertion notification includes a consumable unique identifier.

9. The system of claim 8 wherein the consumable unique identifier is input into a consumables database prior to providing the consumable for use in the multifunction peripheral.

10. The system of claim 8 further comprising the consumable, the consumable including a microchip for generating the consumable insertion notification upon insertion of the consumable into the multifunction peripheral device.

11. The system of claim 7 wherein the order is generated automatically in response to the depletion notification.

12. The system of claim 7 wherein:
the processor is further for generating an order prompt to an administrator in response to receipt of the depletion notification; and
the network interface is further for receiving an order request from the administrator, the order request including the unique identifier.

13. Apparatus comprising a storage medium storing a program having instructions which, when executed by a processor, cause the processor to:
receive a consumable insertion notification in response to the insertion of the consumable into a multifunction peripheral device, the insertion notification including a unique identifier for the multifunction peripheral device;
receive an update regarding a status of the consumable from the multifunction peripheral device;
generate a depletion notification when the update indicates that the consumable has reached a predetermined threshold of depletion; and
process an order for the consumable in response to the depletion notification, the order using the unique identifier to obtain billing preference data and shipping preference data for the multifunction peripheral device obtained from a database.

14. The storage medium of claim 13 wherein the consumable insertion notification includes a consumable unique identifier.

15. The storage medium of claim 14 further comprising inputting the consumable unique identifier into a consumables database prior to providing the consumable for use in the multifunction peripheral.

16. The storage medium of claim 14 wherein the consumable insertion notification is generated by a microchip integral to the consumable and activated by insertion of the consumable into the multifunction peripheral device.

17. The storage medium of claim 13 wherein the order is generated automatically in response to the depletion notification.

18. The storage medium of claim 13, the program further having instructions which, when executed by a processor, cause the processor to:
generate an order prompt to an administrator in response to receipt of the depletion notification; and
receive an order request from the administrator, the order request including the unique identifier.
